(19) United States
(12) Patent Application Publication
(10) Pub. No.: US 2024/0256724 A1
(43) Pub. Date: Aug. 1, 2024

(54) FACILITY LAYOUT DETERMINING METHOD AND FACILITY LAYOUT SYSTEM

(71) Applicant: SAMSUNG ELECTRONICS CO., LTD., Suwon-si (KR)

(72) Inventors: Gyuduck BAE, Suwon-si (KR); Pilsung Koh, Suwon-si (KR); Sangsu Kim, Suwon-si (KR); Kyuman Yeon, Suwon-si (KR); Soyeon Lee, Suwon-si (KR); Bora Jeong, Suwon-si (KR); Boseok Hong, Suwon-si (KR); Jisan Kwak, Suwon-si (KR); Haegeun Park, Suwon-si (KR); Yonghwan Baek, Suwon-si (KR); Chulho Song, Suwon-si (KR); Seungyong Lee, Suwon-si (KR)

(73) Assignee: SAMSUNG ELECTRONICS CO., LTD., Suwon-si (KR)

(21) Appl. No.: 18/424,345

(22) Filed: Jan. 26, 2024

(30) Foreign Application Priority Data
Jan. 27, 2023 (KR) 10-2023-0011118

(51) Int. Cl. G06F 30/13; G06F 111/20

(52) U.S. Cl. CPC G06F 30/13; G06F 2111/20

(57) ABSTRACT

A method of determining a facility layout of a semiconductor factory including a main floor including processing zones, a clean sub-FAB (CSF) floor under the main floor, and a facility sub-FAB (FSF) floor under the CSF floor includes receiving data related to main facilities to be placed on the main floor, CSF subsidiary facilities to be placed on the CSF floor, and FSF subsidiary facilities to be placed on the FSF floor, and determining the facility layout including a layout of the main facilities for the main floor, a layout of the CSF subsidiary facilities for the CSF floor, and a layout of the FSF subsidiary facilities for the FSF floor.

### CROSS-REFERENCE TO RELATED APPLICATION

This application is based on and claims priority under 35 U.S.C. § 119 to Korean Patent Application No. 10-2023-0011118, filed on Jan. 27, 2023, in the Korean Intellectual Property Office, the disclosure of which being incorporated by reference herein in its entirety.

### BACKGROUND

The present disclosure relates to a method of generating a facility layout of a semiconductor factory and a facility layout system for a semiconductor factory.

A semiconductor factory may have a multi-floor structure including a plurality of facilities. An operation of determining a facility layout of the semiconductor factory is largely dependent on a manual operation by an operator. As semiconductor factories become larger and the number of facilities in the semiconductor factories gradually increases, the complexity of the facility layouts, and the time and cost required to determine the facility layouts are gradually increasing.

### SUMMARY

It is an aspect to provide a method of designing a facility layout of a semiconductor factory and a facility layout system for a semiconductor factory.

According to an aspect of one or more embodiments, there is provided a method of determining a facility layout of a semiconductor factory, wherein the semiconductor factory comprises a main floor including a plurality of processing zones, a clean sub-FAB (CSF) floor under the main floor, and a facility sub-FAB (FSF) floor under the CSF floor. The method comprises receiving, by at least one processor, facilities data regarding a plurality of main facilities to be placed on the main floor, a plurality of CSF subsidiary facilities to be placed on the CSF floor, and about a plurality of FSF subsidiary facilities to be placed on the FSF floor; and determining, by the at least one processor, the facility layout including a layout of the plurality of main facilities on the main floor, a layout of the plurality of CSF subsidiary facilities on the CSF floor, and a layout of the plurality of FSF subsidiary facilities on the FSF floor. The determining comprises determining, for each of the plurality of processing zones, a position of each of the plurality of main facilities that are included in the processing zone; determining, for each of the plurality of main facilities, a position of each of one or more of the plurality of FSF subsidiary facilities that are related to the main facility, based on the position of the main facility and the facilities data; and determining, for each of the plurality of main facilities, a position of each of one or more of the plurality of CSF subsidiary facilities that are related to the main facility, based on the facilities data, the determined position of the main facility and the determined position of each of the one or more of the plurality of FSF subsidiary facilities.

According to another aspect of one or more embodiments, there is provided a method of determining a facility layout of a semiconductor factory, wherein the semiconductor factory comprises a main floor including a plurality of processing zones, a clean sub-FAB (CSF) floor under the main floor, and a facility sub-FAB (FSF) floor under the CSF floor. The method comprises receiving, by at least one processor, facilities data related to a plurality of main facilities to be placed on the main floor, about a plurality of CSF subsidiary facilities to be placed on the CSF floor, and about a plurality of FSF subsidiary facilities to be placed on the FSF floor; determining, by the at least one processor, the facility layout including a layout of the plurality of main facilities on the main floor, a layout of the plurality of CSF subsidiary facilities on the CSF floor, and a layout of the plurality of FSF subsidiary facilities on the FSF floor; and generating, by the at least one processor, a layout drawing based on the facility layout. The determining the facility layout comprises determining, for each of the plurality of processing zones, a position of each of the plurality of main facilities included in the processing zone; determining, for each of the plurality of main facilities, a position of each of one or more of the plurality of FSF subsidiary facilities that are related to the main facility, based on the position of the main facility and the facilities data; determining a position of a hole, through which a connection member that connects the main facility with corresponding ones of the plurality of FSF subsidiary facilities passes, in the CSF floor; and determining, for each of the plurality of main facilities, a position of each of one or more of the plurality of CSF subsidiary facilities that are related to the main facility, based on the position of the main facility and the position of each of the of the plurality of FSF subsidiary facilities that are related to the main facility. The determining, for each of the plurality of processing zones, the position of each of the plurality of main facilities included in the processing zone comprises determining representative main facilities among the plurality of main facilities; determining a layout of the representative main facilities; and determining a layout of general main facilities that do not belong to the representative main facilities among the plurality of main facilities.

According to yet another aspect of one or more embodiments, there is provided a facility layout system for a semiconductor factory, wherein the semiconductor factory comprises a main floor including a plurality of processing zones, a clean sub-FAB (CSF) floor under the main floor, and a facility sub-FAB (FSF) floor under the CSF floor, the facility layout system comprising an input device to which facilities data regarding a plurality of main facilities to be placed on the main floor, a plurality of CSF subsidiary facilities to be placed on the CSF floor, and a plurality of FSF subsidiary facilities to be placed on the FSF floor are input; and a layout execution device configured to determine a facility layout of the semiconductor factory, the facility layout including a layout of the plurality of main facilities for the main floor, a layout of the plurality of CSF subsidiary facilities for the CSF floor, and a layout of the plurality of FSF subsidiary facilities for the FSF floor. The layout execution device is configured to, for each of the plurality of processing zones, sequentially perform determining a position of a main facility of the plurality of main facilities included in the processing zone; determining a position of a FSF subsidiary facility of the plurality of FSF subsidiary facilities that is related to the main facility, based on the position of the main facility and the facilities data; and determining a position of a CSF subsidiary facility of the plurality of CSF subsidiary facilities that is related to the main facility, based on the position of the main facility, the position of the FSF subsidiary facility, and the facilities data.

### BRIEF DESCRIPTION OF THE DRAWINGS

Various embodiments will be more clearly understood from the following detailed description taken in conjunction with the accompanying drawings, in which:

FIG. 1 is a block diagram illustrating a facility layout system for a semiconductor factory, according to some embodiments;

FIG. 2 is a conceptual diagram schematically illustrating an example of a facility layout of a semiconductor factory, according to some embodiments;

FIG. 3 is a flowchart illustrating a method of determining a facility layout of a semiconductor factory, according to some embodiments;

FIG. 4 is a flowchart illustrating an example of determining a facility layout of the semiconductor factory of FIG. 3, according to some embodiments;

FIGS. 5A to 5F are diagrams illustrating a method of determining a facility layout, according to some embodiments;

FIG. 6 is a flowchart illustrating an example of a method of determining a facility layout, according to some embodiments;

FIGS. 7A to 7D are diagrams illustrating a method of determining a facility layout, according to some embodiments; and

FIG. 8 is a flowchart illustrating an example of a method of determining a facility layout, according to some embodiments.

### DETAILED DESCRIPTION

Hereinafter, various embodiments are described in detail with reference to the accompanying drawings. The same reference numerals are used for the same components in the drawings, and descriptions already given for the same components are omitted for conciseness.

Herein, a vertical direction may be defined as a Z direction, and each of a first direction and a second direction may be defined as a direction perpendicular to the Z direction. The first direction may be defined as an X direction, and the second direction may be defined as a Y direction. A vertical level may refer to a level in a vertical direction (Z direction). The dimension of a facility may refer to the length of the facility in the first direction (X direction), the length thereof in the second direction (Y direction), the length thereof in a vertical direction (Z direction), and/or the planar area thereof (i.e., the area thereof occupied on the XY plane).

A semiconductor factory may have a multi-floor structure including a main-fab floor on which production facilities are placed and a sub-fab floor on which subsidiary facilities are placed. An operation of determining a facility layout of each of a plurality of floors of a semiconductor factory is largely dependent on a manual operation by an operator. Thus, as semiconductor factories become larger and the number of facilities in the semiconductor factories gradually increases, the complexity of the facility layout increases and the time and cost required to determine facility layouts are gradually increasing.

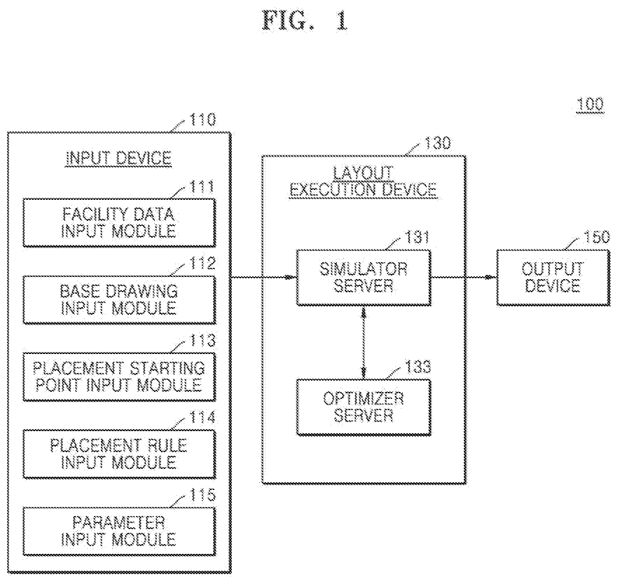

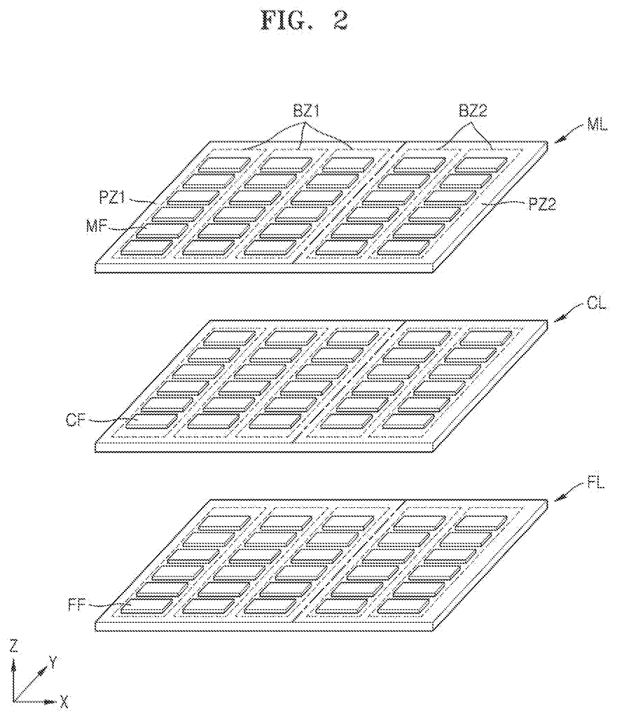

FIG. 1 is a block diagram illustrating a facility layout system 100 for a semiconductor factory, according to some embodiments. FIG. 2 is a conceptual diagram schematically illustrating an example of a facility layout of a semiconductor factory, according to some embodiments.

Referring to FIGS. 1 and 2, the facility layout system 100 for the semiconductor factory may be configured to generate a facility layout of each of a plurality of floors of the semiconductor factory. The generation of the facility layout may include determining the positions of facilities for each of the plurality of floors, and generating a layout drawing based on the determined positions of the facilities for each of the plurality of floors.

The semiconductor factory may include a main floor ML on which main facilities MF are placed and a sub-floor on which subsidiary facilities are placed. The main floor ML and the sub-floor may be spaced apart from each other in the vertical direction (Z direction). Each of the main floor ML and the sub-floor may be implemented by a structure (for example, bottom wall) of the semiconductor factory. The position of a facility on the main floor ML may be defined by X-Y coordinates according to an X-Y coordinate system, and the position of a facility on the sub-floor may be defined by X-Y coordinates according to the X-Y coordinate system. The sub-floor may be a single floor or a multi-floor structure.

The main floor ML may provide a space in which a semiconductor process is performed, and the space provided on the main floor ML may include a clean room. The main facilities MF of the main floor ML may refer to facilities configured to perform a semiconductor process on a substrate. For example, the main facilities MF may provide a space for accommodating a substrate and may perform a semiconductor process on the substrate. For example, the main facilities MF configured to perform, on a substrate, a diffusion process, a photolithography process, an etching process, a deposition process, a metallization process, an ion implantation process, a cleaning process, a polishing process, and/or a packaging process may be provided on the main floor ML. The main floor ML may include a plurality of processing zones, and the plurality of processing zones may be configured to perform different semiconductor processes.

FIG. 2 illustrates that the main floor ML has two processing zones (i.e., a first processing zone PZ1 and a second processing zone PZ2). However, this is only an example and, in some embodiments, the main floor ML may include at least three processing zones.

Each of the processing zones may include a plurality of bay zones spaced apart from each other in the first direction (X direction). For example, the first processing zone PZ1 may include a plurality of first bay zones BZ1, and the second processing zone PZ2 may include a plurality of second bay zones BZ2. For example, the first processing zone PZ1 may include three first bay zones BZ1, and the second processing zone PZ2 may include two second bay zones BZ2, as illustrated in FIG. 2. However, this is only an example and, in some embodiments, the number of bay zones may be different. Each of the bay zones may include the main facilities MF arranged in the second direction (Y direction). For example, the main facilities MF may be arranged along a bay reference line parallel to the second direction (Y direction), in each of the bay zones. Each of the bay zones may include the main facilities MF of the same type or may include a combination of the main facilities MF of various types.

The subsidiary facilities of the sub-floor may be related to the main facilities MF of the main floor ML. The subsidiary facilities of the sub-floor may include a facility for providing substances, such as process gas or chemical substances, to the main facility MF, a facility for removing residues (for example, exhausting gas) from the main facility MF, and a facility (for example, a chiller, a pump, or a scrubber) for providing an appropriate process environment to the main facility MF. Each of the subsidiary facilities is related to each of the main facilities MF, and each of the subsidiary facilities and each of the main facilities MF may be connected to each other via a connection member (for example, a pipe, a duct, or a cable). Herein, each of the subsidiary facilities may refer to a single facility or a combination of various facilities that are functionally and/or physically distinguished from each other. In some embodiments, some of the main facilities MF may not require the subsidiary facility of the sub-floor.

In some embodiments, the sub-floor may include a clean sub-FAB (CSF) floor CL and a facility sub-FAB (FSF) floor FL. The CSF floor CL may be placed under the main floor ML, and the FSF floor FL may be placed under the CSF floor CL.

CSF subsidiary facilities CF may be placed on the CSF floor CL. The CSF floor CL may have a plurality of zones respectively corresponding to the plurality of processing zones of the main floor ML, and each of the plurality of zones of the CSF floor CL may include a plurality of bay zones arranged in the second direction (Y direction). In some embodiments, the plurality of bay zones may respectively correspond to the plurality of bay zones of the main floor ML. The CSF subsidiary facilities CF may include, for example, a facility (for example, a gas supply cabinet) for providing substances, such as process gas or chemical substances, to the main floor ML. The CSF subsidiary facilities CF may be connected to the main facilities MF via connection members. For example, a gas supply cabinet on the CSF floor CL may be connected to a processing chamber of a main facility MF on the main floor ML by a connection member. In some embodiments, each of the CSF subsidiary facilities CF may be connected to each of the main facilities MF via a connection member. In some embodiments, the position of the CSF subsidiary facilities CF may be determined based on the position of the main facilities MF, and the CSF subsidiary facilities CF and the main facilities MF, which are related to each other, may substantially vertically overlap. In some embodiments, the position of each of the CSF subsidiary facilities CF may be determined based on the position of each of the main facilities MF, and each of the CSF subsidiary facilities CF and each of the main facilities MF, which are related to each other, may substantially vertically overlap.

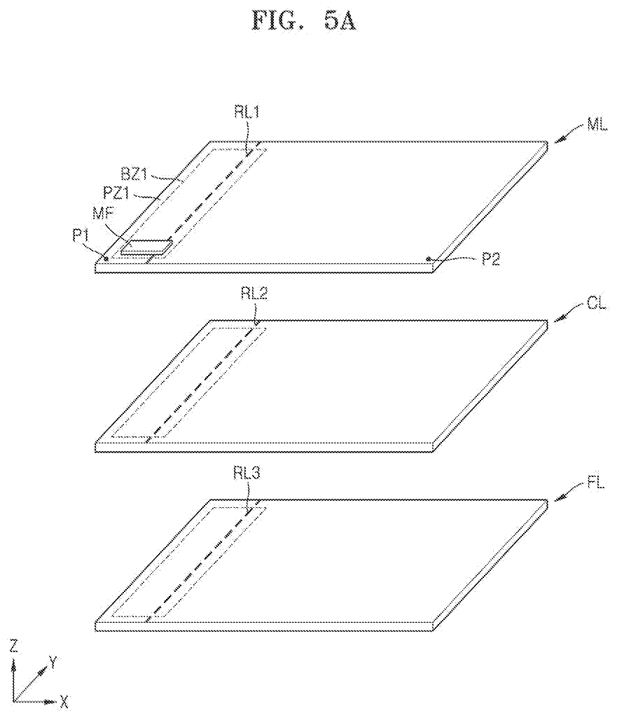

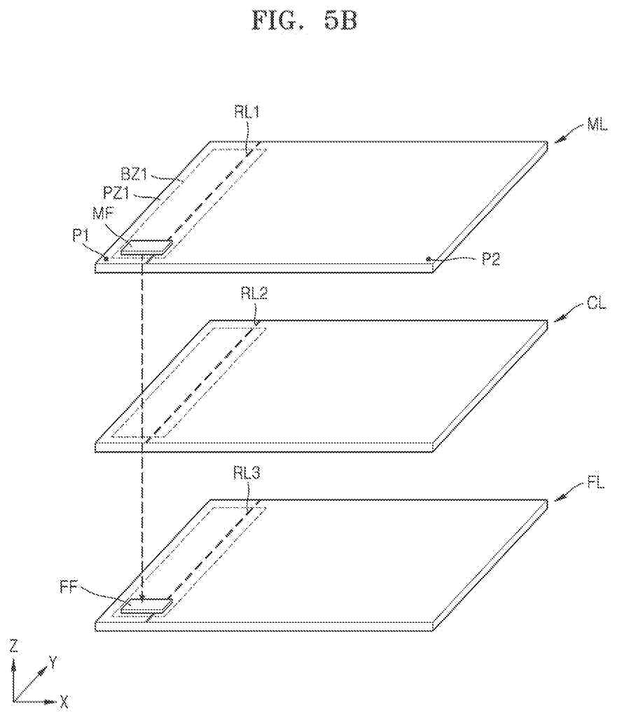

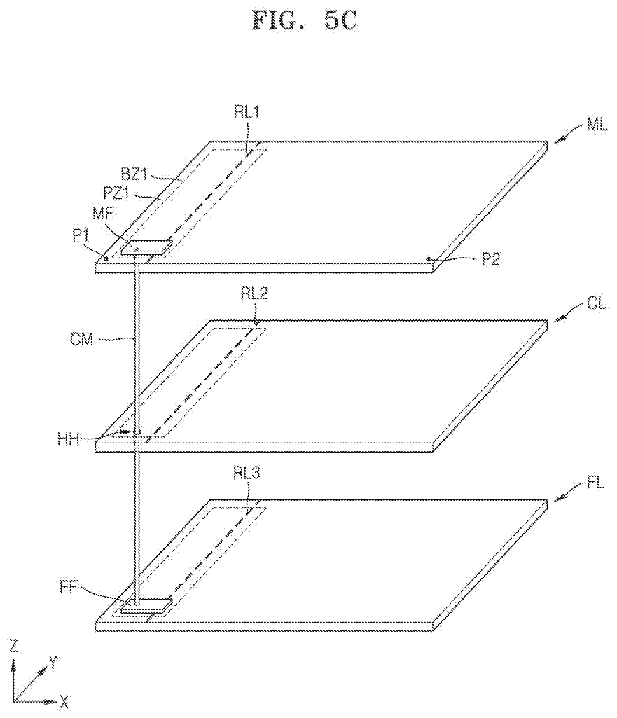

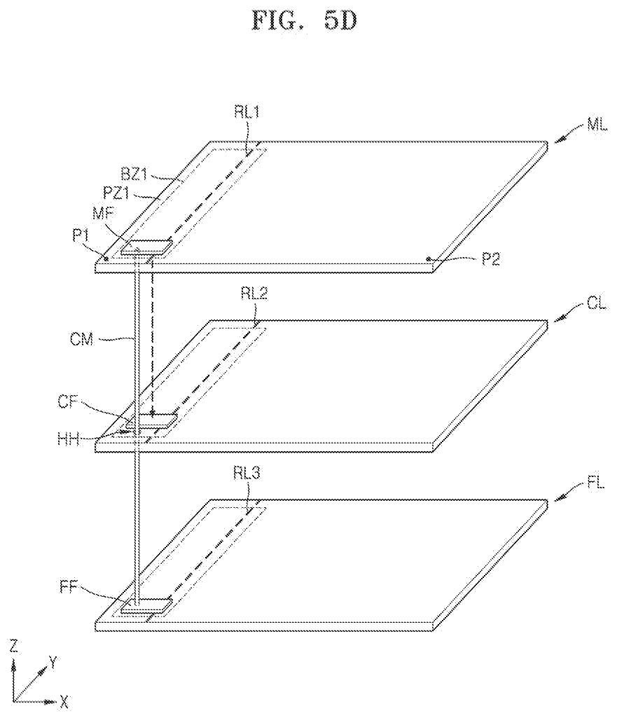

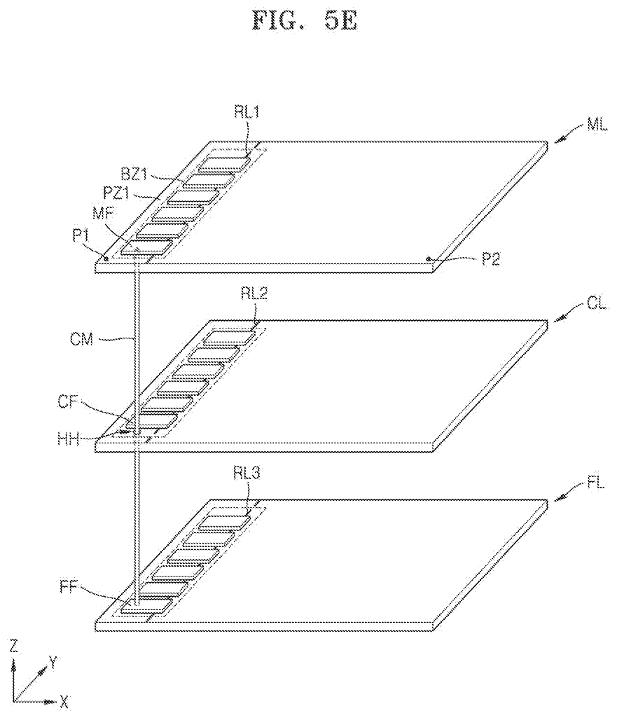

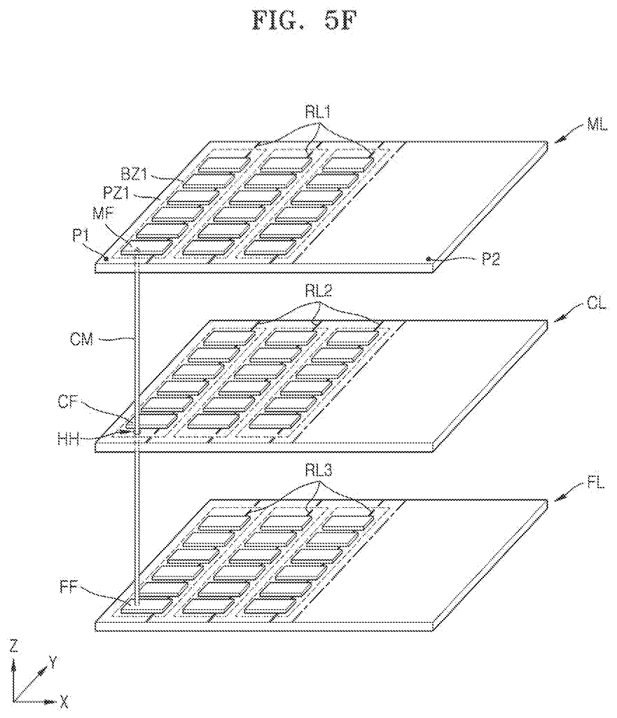

FSF subsidiary facilities FF may be placed on the FSF floor FL. The FSF floor FL may have a plurality of zones respectively corresponding to the plurality of processing zones of the main floor ML, and each of the plurality of zones of the FSF floor FL may include a plurality of bay zones arranged in the second direction (Y direction). In some embodiments, the plurality of bay zones may respectively correspond to the plurality of bay zones of the main floor ML. The FSF subsidiary facilities FF may include, for example, a scrubber, a chiller, and/or a pump. In some embodiments, the FSF subsidiary facilities FF may be connected to the main facilities MF via connection members. In some embodiments, each of the FSF subsidiary facilities FF may be connected to each of the main facilities MF via a connection member (CM of FIG. 5F). In some embodiments, the position of the FSF subsidiary facilities FF may be determined based on the position of the main facilities MF, and the FSF subsidiary facilities FF and the main facilities MF, which are related to each other, may substantially vertically overlap. In some embodiments, the position of each of the FSF subsidiary facilities FF may be determined based on the position of each of the main facilities MF, and each of the FSF subsidiary facilities FF and each of the main facilities MF, which are related to each other, may substantially vertically overlap.

In some embodiments, the main facilities MF may require both a CSF subsidiary facility CF and a FSF subsidiary facility FF, or the main facilities MF may require only one of the CSF subsidiary facility CF and the FSF subsidiary facility FF, or the main facilities MF may require none of the CSF subsidiary facility CF and the FSF subsidiary facility FF. In some embodiments, each of the main facilities MF may require both a CSF subsidiary facility CF and a FSF subsidiary facility FF, or may require only one of the CSF subsidiary facility CF and the FSF subsidiary facility FF, or may require none of the CSF subsidiary facility CF and the FSF subsidiary facility FF.

The generation of the facility layout may include determining a facility layout of the main floor ML, determining a facility layout of the CSF floor CL, and determining a facility layout of the FSF floor FL. The determining of the facility layout of the main floor ML may include determining a layout of the main facilities MF for each of the processing zones of the main floor ML, the determining of the facility layout of each of the zones of the CSF floor CL may include determining a layout of the CSF subsidiary facilities CF for the zone, and the determining of the facility layout of each of the zones of the FSF floor FL may include determining a layout of the FSF subsidiary facilities FF for the zone.

The facility layout system 100 of the semiconductor factory may include an input device 110, a layout execution device 130, and an output device 150.

The input device 110 may include a web-based interface for receiving, from an operator, an input of information used for generating a facility layout and/or a library storing information used for generating a facility layout. In some embodiments, the input device may be implemented by at least one processor that executes a computer program to provide the web-based interface. In some embodiments, the input device may be implemented by at least one processor that executes a computer program to read the library information from a memory device.

The input device 110 may include a facility data input module 111, a base drawing input module 112, a placement starting point input module 113, a placement rule input module 114, and a parameter input module 115. The facility data input module 111, the base drawing input module 112, the placement starting point input module 113, the placement rule input module 114, and the parameter input module 115 may be implemented by the web-based interface and/or the library. In some cases, the facility data input module 111, the base drawing input module 112, the placement starting point input module 113, the placement rule input module 114, and the parameter input module 115 may be respectively referred to as a facility data library, a base drawing library, a placement starting point library, a placement rule library, and a parameter library.

The facility data input module 111 may receive and store data about the main facilities MF placed on the main floor ML, data about the CSF subsidiary facilities CF placed on the CSF floor CL, and data about the FSF subsidiary facilities FF placed on the FSF floor FL. The data about the main facilities MF may include the specification of each of the main facilities MF, the dimension of each of the main facilities MF, the size of a maintenance space for each of the main facilities MF, and/or the size of a carry-in/carry-out space for the carry-in/carry-out of each of the main facilities MF. The data about the CSF subsidiary facilities CF may include the specification of each of the CSF subsidiary facilities CF, the dimension of each of the CSF subsidiary facilities CF, the size of a maintenance space for each of the CSF subsidiary facilities CF, the size of a carry-in/carry-out space for the carry-in/carry-out of each of the CSF subsidiary facilities CF, and/or data about the relationship between the main facilities MF and the CSF subsidiary facilities CF. The data about the relationship may be data about the relationship between each of the main facilities MF and each of the CSF subsidiary facilities CF. The data about the FSF subsidiary facilities FF may include the specification of each of the FSF subsidiary facilities FF, the dimension of each of the FSF subsidiary facilities FF, the size of a maintenance space for each of the FSF subsidiary facilities FF, the size of a carry-in/carry-out space for the carry-in/carry-out of each of the FSF subsidiary facilities FF, and data about the relationship between the main facilities MF and the FSF subsidiary facilities FF. The data about the relationship may be data about the relationship between each of the main facilities MF and each of the FSF subsidiary facilities FF. In some embodiments, the facility data input module 111 may receive and store information (for example, the number, dimension, and type of connection members) about a connection member for connecting the main facilities MF with the CSF subsidiary facilities CF, and information (for example, the number, dimension, and type of connection members) about a connection member for connecting the main facilities MF with the FSF subsidiary facilities FF. In some embodiments, the facility data input module 111 may receive and store information (for example, the number, dimension, and type of connection members) about a connection member for connecting each of the main facilities MF with each of the CSF subsidiary facilities CF, and information (for example, the number, dimension, and type of connection members) about a connection member for connecting each of the main facilities MF with each of the FSF subsidiary facilities FF.

The base drawing input module 112 may receive and store data about a base drawing of each of the plurality of floors of the semiconductor factory. The base drawing input module 112 may receive and store a first base drawing of the main floor ML, a second base drawing of the CSF floor CL, and a third base drawing of the FSF floor FL. The first to third base drawings may each be a two-dimensional drawing, and a position of a point in each of the first to third base drawings may be represented by X-Y coordinates. The first base drawing may include information about an outer boundary line of the main floor ML and a zone within the main floor ML, in which facilities cannot be placed. The zone in which facilities cannot be placed may include columns of a building. The second base drawing may include information about an outer boundary line of the CSF floor CL and a zone within the CSF floor CL, in which facilities cannot be placed. The zone in which facilities cannot be placed may include columns of a building. The third base drawing may include information about a boundary line of the FSF floor FL and a zone within the FSF floor FL, in which facilities cannot be placed. The zone in which facilities cannot be placed may include columns of a building.

The placement starting point input module 113 may receive and store information about a plurality of placement starting points of the main floor ML. The plurality of placement starting points are points on the first base drawing of the main floor ML, and each of the plurality of placement starting points may be defined by X-Y coordinates. In some embodiments, the facility layout for the main floor ML may be performed individually for each of the processing zones. In each of the processing zones, the positions of the main facilities MF may be sequentially determined along a path starting from one placement starting point selected from among the plurality of placement starting points.

More specifically, determining a facility layout of one processing zone may include sequentially determining facility layouts of a plurality of bay zones included in one processing zone. A facility layout of a bay zone, which is closest to a placement starting point designated for a corresponding processing zone, among a plurality of bay zones may be determined first, and a facility layout of another bay zone on one side of the preceding bay zone for which the facility layout has been determined in the preceding operation may be determined in a subsequent operation. The positions of the main facilities MF may be sequentially determined along a bay reference line parallel to the second direction (Y direction), within each of the bay zones.

The placement rule input module 114 may receive and store a placement rule for each of the plurality of floors of the semiconductor factory. The placement rule input module 114 may receive and store information about a placement rule with which the layout of the main facilities MF of the main floor ML has to comply, a placement rule with which the layout of the CSF subsidiary facilities CF of the CSF floor CL has to comply, and a placement rule with which the layout of the FSF subsidiary facilities FF of the FSF floor FL has to comply.

The parameter input module 115 may receive and store information about at least one parameter used to determine a facility layout. In some embodiments, the parameter input module 115 may receive and store a floor-specific weight parameter related to an optimization weight for each of the plurality of floors of the semiconductor factory. The floor-specific weight parameter may include a first optimization weight parameter of the main floor ML, a second optimization weight parameter of the CSF floor CL, and a third optimization weight parameter of the FSF floor FL. Each of the first to third optimization weight parameters may have a value greater than or equal to 0 and less than 1, and a total sum of the first to third optimization weight parameters may be 1. The floor-specific weight parameter may be related to the optimization priority of a corresponding floor. In the process of determining a layout of a plurality of floors (i.e., the main floor ML, the CSF floor CL, and the FSF floor FL), the higher the optimization weight parameter of a corresponding floor, the higher priority may be given to optimizing a layout of facilities of the corresponding floor. The higher the optimization weight parameter of a corresponding floor, the less dead space that the corresponding floor has. The facility data input module 111, the base drawing input module 112, the placement starting point input module 113, the placement rule input module 114, and the parameter input module 115 have been described above as receiving and storing the data. However, in some embodiments, as discussed above, the facility data input module 111, the base drawing input module 112, the placement starting point input module 113, the placement rule input module 114, and the parameter input module 115 may also be implemented as library information which is stored on a memory device and read.

The layout execution device 130 may include at least one memory storing computer code and at least one processor configured to access the at least one memory and execute the computer code to determine and generate a facility layout of the semiconductor factory based on information provided from the input device 110. The layout execution device 130 may include a simulator server 131 and an optimizer server 133.

The simulator server 131 may include at least one memory storing computer code and at least one processor configured to access the at least one memory and execute the computer code to receive information for determining a facility layout from the input device 110 and perform a simulation operation for determining a facility layout based on the received information.

The optimizer server 133 may include at least one memory storing computer code and at least one processor configured to access the at least one memory and execute the computer code to communicate with the simulator server 131 and control the operation of the simulator server 131. The optimizer server 133 may check an operation progress of the simulator server 131 in real time and may provide an operation command to the simulator server 131 such that the simulator server 131 performs a specific operation. The optimizer server 133 may perform a pre-processing operation on various types of information provided from the input device 110 and may provide various algorithms for performing a simulation operation on a facility layout. The simulator server 131 may operate according to the operation command of the optimizer server 133 to perform a calculation operation for determining a facility layout of each of the plurality of floors of the semiconductor factory. For example, the simulator server 131 may generate one facility layout or a plurality of different facility layouts. When the simulator server 131 generates a plurality of facility layouts, one of the plurality of facility layouts may be determined as a final facility layout by an operator or by the optimizer server 133.

The output device 150 may include at least one memory storing computer code and at least one processor configured to access the at least one memory and execute the computer code to generate and output a layout drawing of the semiconductor factory based on the determined facility layout provided from the simulator server 131. The layout drawing of the semiconductor factory may be provided as a two-dimensional drawing of a facility layout of each of the plurality of floors of the semiconductor factory or a three-dimensional drawing of the plurality of floors of the semiconductor factory. The layout drawing may be provided as a physical drawing output on a display, or as a drawing file (for example, a CAD file). While each of the input device 110, the layout execution device 130 and the output device 150 are described above as including a separate processor, this is only an example and, in some embodiments, the input device 110, the layout execution device 130 and the output device 150 may be implemented by a single processor or hardware control logic.

In some embodiments, there is provided a method of determining a facility layout of a semiconductor factory by using the facility layout system 100 for the semiconductor factory, and furthermore, there is provided a method of manufacturing a semiconductor factory including a method of determining a facility layout of the semiconductor factory. The method of manufacturing the semiconductor factory may include manufacturing the semiconductor factory by proceeding with building construction based on a layout drawing of the semiconductor factory generated via the method of determining the facility layout of the semiconductor factory.

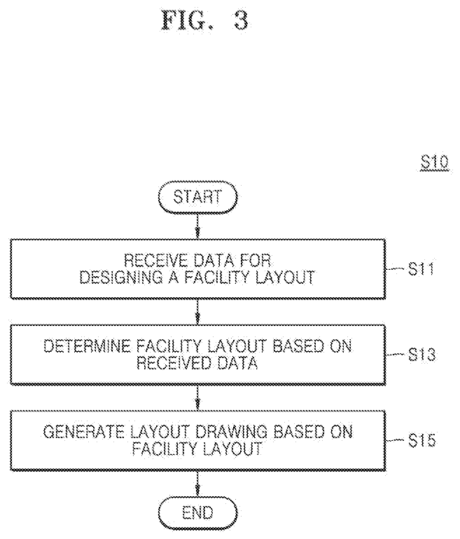

FIG. 3 is a flowchart illustrating a method of determining a facility layout of a semiconductor factory (S10), according to some embodiments.

Referring to FIG. 3 together with FIGS. 1 and 2, the method of determining the facility layout of the semiconductor factory (S10) may include receiving data for determining a facility layout (S11), determining the facility layout (S13), and generating a layout drawing (S15).

In operation S11, the data for determining the facility layout may be received from the facility data input module 111, the base drawing input module 112, the placement starting point input module 113, the placement rule input module 114, and the parameter input module 115 of the input device 110 described with reference to FIG. 1.

The operation S13 may be performed by the layout execution device 130.

In operation S13, a facility layout is determined based on the receive data. In some embodiments, the facility layout of each of the processing zones of the main floor ML is determined individually. In the process of determining the layout of the main facilities MF for each of the processing zones, the layout of the CSF subsidiary facilities CF for a zone of the CSF floor CL related to the processing zone of the main floor ML and the layout of the FSF subsidiary facilities FF for a zone of the FSF floor FL related to the processing zone of the main floor ML may be determined together.

In operation S13, in some embodiments, facility layout for at least two processing zones in the plurality of processing zones of the main floor ML may be simultaneously performed. For example, determining a layout of the main facilities MF for the first processing zone PZ1 and determining a layout of the main facilities MF for the second processing zone PZ2 may be simultaneously performed. In some embodiments, facility layouts of the plurality of processing zones of the main floor ML may be sequentially determined. For example, after a layout of the main facilities MF for the first processing zone PZ1 is determined, determining a layout of the main facilities MF for the second processing zone PZ2 may be performed.

In operation S15, a layout drawing may be generated based on the facility layout. The layout drawing may be generated via the output device 150 described with reference to FIG. 1. The layout drawing may include a layout drawing of the main floor ML, a layout drawing of the CSF floor CL, and a layout drawing of the FSF floor FL.

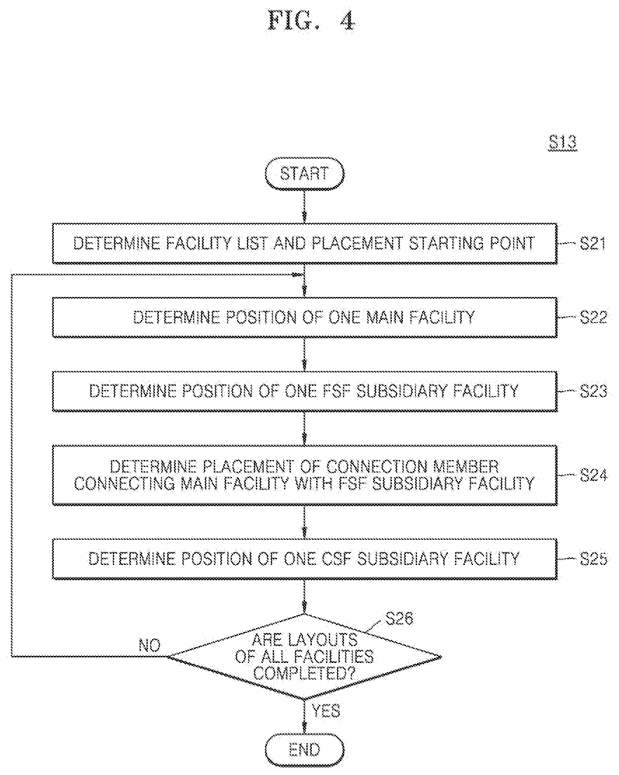

FIG. 4 is a flowchart illustrating an example of the determining of the facility layout (S13) of FIG. 3, according to some embodiments. FIGS. 5A to 5F are diagrams illustrating a method of determining a facility layout, according to some embodiments.

Hereinafter, a method of determining a facility layout of the first processing zone PZ1 of the main floor ML, a zone (hereinafter, referred to as a first CSF zone) of the CSF floor CL, which is related to the first processing zone PZ1 of the main floor ML, and a zone (hereinafter, referred to as a first FSF zone) of the FSF floor FL, which is related to the first processing zone PZ1 of the main floor ML, is described with reference to FIGS. 4 and 5A to 5F. In other words, a method of determining each of a layout of the main facilities MF for the first processing zone PZ1 of the main floor ML, a layout of the CSF subsidiary facilities CF for the first CSF zone of the CSF floor CL, and a layout of the FSF subsidiary facilities FF for the first FSF zone of the FSF floor FL is described.

Referring to FIG. 4, a facility list and a placement starting point are determined (S21). The facility list may include a main facility list of the main facilities MF for the first processing zone PZ1 of the main floor ML, a list of the CSF subsidiary facilities CF for the first CSF zone of the CSF floor CL, and a list of the FSF subsidiary facilities FF for the first FSF zone of the FSF floor FL. In operation S21, one of the plurality of placement starting points (for example, a first placement starting point P1 and a second placement starting point P2) set on the first base drawing of the main floor ML may be determined as a placement starting point of the first processing zone PZ1. In the present example, the first placement starting point P1 is determined as the placement starting point of the first processing zone PZ1.

Referring to FIGS. 4 and 5A, the position of one main facility MF is determined (S22). In operation S22, the main facility MF, which is placed in a first order on the main floor ML, among the main facilities MF is included in a first bay zone BZ1. The first bay zone BZ1 may be closest to the placement starting point, among the plurality of first bay zones BZ1 of the first processing zone PZ1. The position of the main facility MF placed in the first order may be closest to the placement starting point among the positions of the main facilities MF allocated to the first processing zone PZ1.

Referring to FIGS. 4 and 5B, the position of the FSF subsidiary facility FF related to the main facility MF is determined based on the determined position of the main facility MF (S23). For example, the FSF subsidiary facility FF that is related to the main facility MF may be determined based on the received data indicating the relationship between the main facilities MF and the FSF subsidiary facilities FF. The position of the FSF subsidiary facility FF may substantially vertically overlap the determined position of the main facility MF.

Referring to FIGS. 4 and 5C, the placement of a connection member CM connecting between the main facility MF and the FSF subsidiary facility FF, which are related to each other, is determined (S24). The determining of the placement of the connection member CM may include determining a path of the connection member CM extending between a target point of the main facility MF and a target point of the FSF subsidiary facility FF and determining the position of a hole for the connection member CM to pass through. In operation S24, the position of a hole HH of the CSF floor CL for passage of the connection member CM may be determined as coordinates on the second base drawing of the CSF floor CL.

Referring to FIGS. 4 and 5D, the position of a CSF subsidiary facility CF related to the main facility MF is determined (S25). That is, the positon of the CSF subsidiary facility CF is determined based on the determined position of the main facility MF and the determined position of the FSF subsidiary facility FF. The position of the CSF subsidiary facility CF may substantially vertically overlap the determined position of the main facility MF and the determined position of the FSF subsidiary facility FF. In operation S25, the position of the CSF subsidiary facility CF may be determined so as not to interfere with (or so as to be spaced apart by an appropriate distance from) the connection member CM and the hole HH of the CSF floor CL through which the connection member CM passes. In other words, the phrase “substantially vertically overlap” denotes that the position of the CSF subsidiary facility CF vertically overlaps the determined position of the main facility MF and the determined position of the FSF subsidiary facility FF except for an allowance for the connection member CM and the hole HH so as not to interfere with the connection member CM and the hole HH. Herein, one main facility MF, the FSF subsidiary facility FF related to the one main facility MF, and the CSF subsidiary facility CF related to the one main facility MF are defined as constituting one related-facility set, and determining the position of the one related-facility set may mean that the positions of the main facility MF, the FSF subsidiary facility FF, and the CSF subsidiary facility CF, which belong to the related-facility set, are determined.

Next, after the position of each of the main facility MF, the CSF subsidiary facility CF, and the FSF subsidiary facility FF, which are related to each other (i.e., one related-facility set), is determined via operation S22 to operation S25, it is determined whether layouts of all facilities included in the facility list are completed (S26).

In operation S26, when it is determined that the layouts of all facilities included in the facility list are not completed (S26, NO), operation S22 to operation S25 may be repeatedly performed until the layouts of all facilities included in the facility list are determined.

More specifically, as shown in FIG. 5E, a layout of the main facilities MF for one first bay zone BZ1 of the first processing zone PZ1, a layout of the FSF subsidiary facilities FF for one bay zone of the first FSF zone, and a layout of the CSF subsidiary facilities CF for one bay zone of the first CSF zone may be determined by performing operation S22 to operation S25 several times. Afterwards, as shown in FIG. 5F, a layout of the main facilities MF for all first bay zones BZ1 of the first processing zone PZ1, a layout of the FSF subsidiary facilities FF for all bay zones of the first FSF zone, and a layout of the CSF subsidiary facilities CF for all bay zones of the first CSF zone may be determined by performing operation S22 to operation S25 several times.

The main facilities MF in each of the first bay zones BZ1 of the first processing zone PZ1 may be aligned along corresponding first bay reference lines RL1 parallel to the second direction (Y direction), the CSF subsidiary facilities CF in each of the bay zones of the first CSF zone may be aligned along corresponding second bay reference lines RL2 parallel to the second direction (Y direction), and the FSF subsidiary facilities FF in each of the bay zones of the first FSF zone may be aligned along corresponding third bay reference line RL3 parallel to the second direction (Y direction). For example, the main facilities MF in the leftmost first bay zone BZ1 of the first processing zone PZ1 may be aligned along a corresponding first bay reference line RL1 as illustrated in FIG. 5F, the CSF subsidiary facilities CF in the leftmost bay zone of the first CSF zone may be aligned along a corresponding second bay reference line RL2, and the FSF subsidiary facilities FF in the leftmost bay zone of the first FSF zone may be aligned along a corresponding third bay reference line RL3.

The determining of the facility layout of the first processing zone PZ1 may include sequentially determining facility layouts of the plurality of first bay zones BZ1 included in the first processing zone PZ1. A facility layout of the first bay zone BZ1, which is closest to the first placement starting point P1, among the plurality of first bay zones BZ1 may be determined first, and a facility layout of another first bay zone BZ1 on one side of the first bay zone BZ1 for which the facility layout has been determined in the preceding operation may be determined in a subsequent operation. The positions of the main facilities MF may be sequentially determined along the first bay reference line RL1 parallel to the second direction (Y direction), within each of the first bay zones BZ1. After a facility layout of one bay zone is determined in the first FSF zone and the first CSF zone, a facility layout of another bay zone on one side of the bay zone for which the facility layout has been determined in the preceding operation may be determined in a subsequent operation.

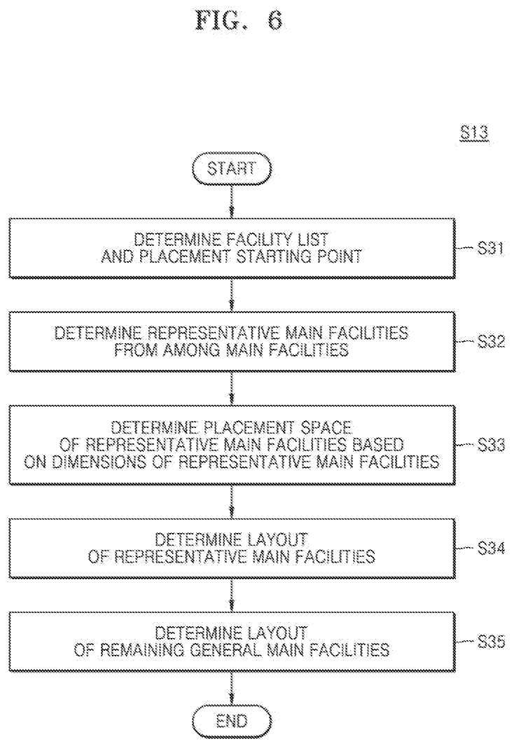

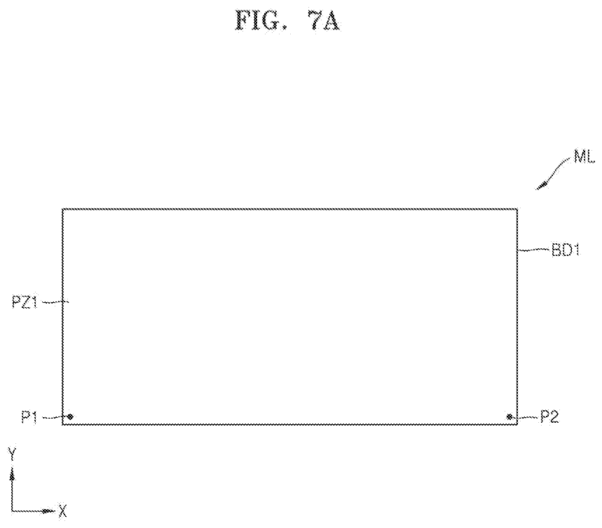

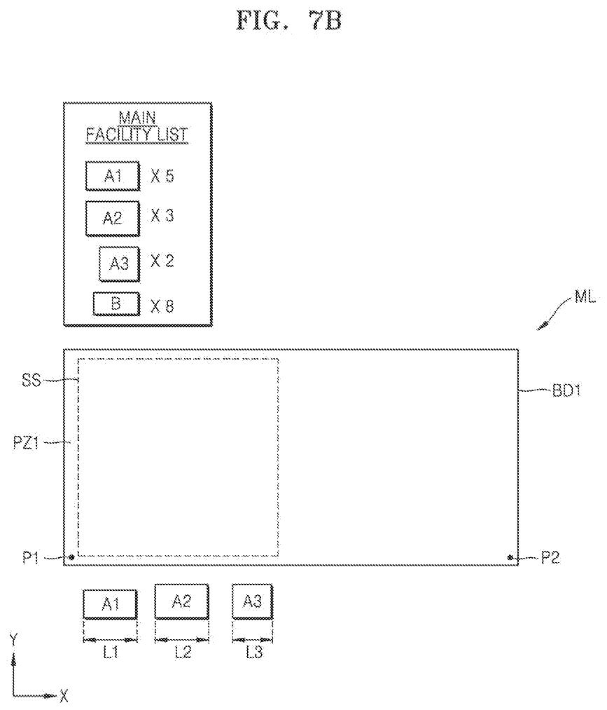

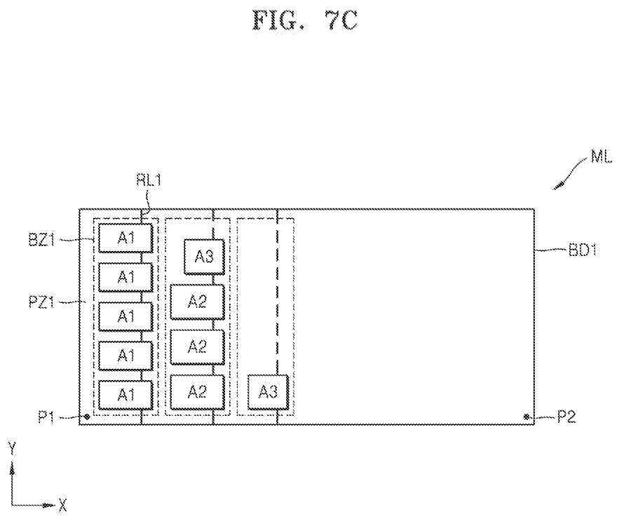

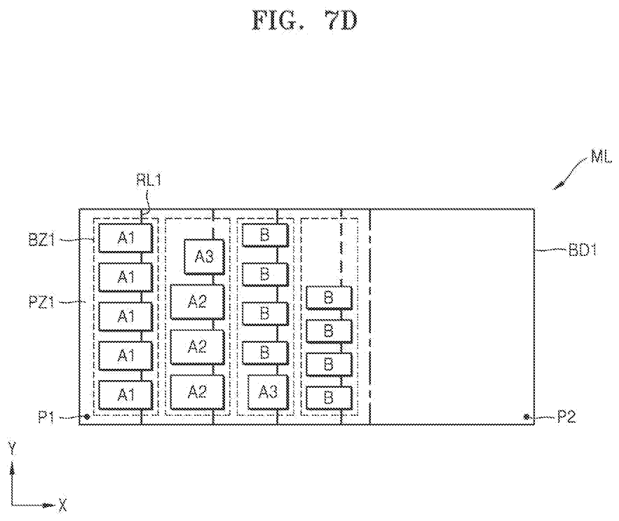

FIG. 6 is a flowchart illustrating an example of a method of determining a facility layout, according to some embodiments. FIGS. 7A to 7D are diagrams illustrating a method of determining a facility layout, according to some embodiments. In some embodiments, the example of the method of determining the facility layout of FIG. 6 may correspond to operation S13 in FIG. 3.

Hereinafter, a method of determining each of a layout of the main facilities MF for the first processing zone PZ1 of the main floor ML, a layout of the CSF subsidiary facilities CF for the first CSF zone of the CSF floor CL, and a layout of the FSF subsidiary facilities FF for the first FSF zone of the FSF floor FL is described with reference to FIGS. 6 and 7A to 7D. Descriptions that are the same as the descriptions given above are omitted or simplified for conciseness.

Referring to FIGS. 6 and 7A, a facility list and a placement starting point are determined (S31). Operation S31 may be substantially the same as operation S21 of FIG. 4. In operation S31, a main facility list of the main facilities MF for the first processing zone PZ1 of the main floor ML, a list of the CSF subsidiary facilities CF for the first CSF zone of the CSF floor CL, and a list of the FSF subsidiary facilities FF for the first FSF zone of the FSF floor FL may be determined. In operation S31, the first placement starting point P1 on a first base drawing BD1 of the main floor ML is determined as a placement starting point of the first processing zone PZ1.

Referring to FIGS. 6 and 7B, representative main facilities are determined from among the main facilities MF included in the main facility list (S32). For example, the main facilities MF included in the main facility list may be classified into representative main facilities and general main facilities B not determined as representative facilities. The representative main facilities may be classified into various types of facilities. In some embodiments, the representative main facilities may include a first facility group including at least one first-type representative facility A1, a second facility group including at least one second-type representative facility A2, and a third facility group including at least one third-type representative facility A3. In the example of FIG. 7B, the main facilities MF may be classified into the first facility group including five first-type representative facilities A1, the second facility group including three second-type representative facilities A2, the third facility group including two third-type representative facilities A3, and a general facility group including eight general main facilities B. The eight general main facilities B may include different types of facilities.

Next, the dimension of a placement space SS for the representative main facilities is determined based on the dimensions of the representative main facilities (S33). An area having a minimum length in the first direction (X direction) among areas including all of one first-type representative facility A1, one second-type representative facility A2, and one third-type representative facility A3, which are arranged in the first direction (X direction), may be determined as the placement space SS. In some embodiments, the length of the placement space SS in the first direction (X direction) may be determined by a length L1 of the first-type representative facility A1 in the first direction (X direction), a length L2 of the second-type representative facility A2 in the first direction (X direction), a length L3 of the third-type representative facility A3 in the first direction (X direction), and a preset distance between facilities (or a distance between bay zones). The length of the placement space SS in the second direction (Y direction) may be similar to the length of the first base drawing BD1 in the second direction (Y direction). The reproducibility of the facility layout may increase by determining a layout of all representative main facilities after the placement space SS is preset. If, in a subsequent operation, it is determined that it is difficult to place all representative main facilities within the placement space SS, the dimension of the placement space SS is expanded, and then, the layout of all representative main facilities is re-determined.

Referring to FIGS. 6 and 7C, a layout of the representative main facilities is determined (S34). In some embodiments, when the layout of the representative main facilities is determined, the placement order of the representative main facilities may be determined according to the type of the representative main facilities, and the main facilities MF of the same type may be placed consecutively. In other words, representative main facilities belonging to the same group among a plurality of facility groups may be placed consecutively. For example, after a layout of the first facility group is completed by consecutively determining a layout of all first-type representative facilities A1 belonging to the first facility group, a layout of the second facility group may be completed by consecutively determining a layout of the second-type representative facilities A2 belonging to the second facility group.

In some embodiments, when a facility layout is determined for each facility group, the order of determining a layout of a corresponding facility group may be proportional to the number of facilities belonging to the corresponding facility group. For example, layout of the first facility group including five first-type representative facilities A1, layout of the second facility group including three second-type representative facilities A2, and layout of the third facility group including two third-type representative facilities A3 may be sequentially performed.

In operation S34, while the layout of the representative main facilities is determined, a layout of each of the FSF subsidiary facilities FF related to each of the representative main facilities and a layout of each of the CSF subsidiary facilities CF related to each of the representative main facilities may be determined together.

Referring to FIGS. 6 and 7D, after the layout of all representative main facilities is determined, a layout of the remaining general main facilities B is determined (S35). While the layout of the general main facilities B is determined, a layout of each of the FSF subsidiary facilities FF related to each of the general main facilities B and a layout of each of the CSF subsidiary facilities CF related to each of the general main facilities B may be determined together.

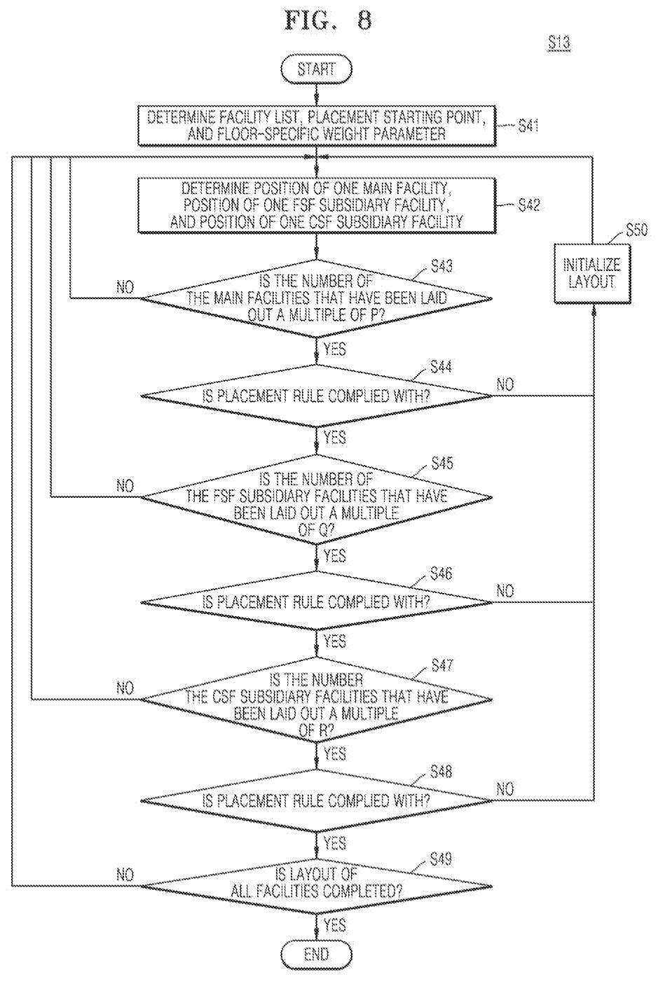

FIG. 8 is a flowchart illustrating an example of a method of determining a facility layout, according to some embodiments.

Hereinafter, a method of determining a layout of the main facilities MF for the first processing zone PZ1 of the main floor ML, a layout of the CSF subsidiary facilities CF for the first CSF zone of the CSF floor CL, and a layout of the FSF subsidiary facilities FF for the first FSF zone of the FSF floor FL is described with reference to FIG. 8 together with FIG. 5F. Descriptions that are the same as the descriptions given above are omitted or simplified for conciseness. In some embodiments, the example of the method of determining the facility layout of FIG. 8 may correspond to operation S13 in FIG. 3.

First, a facility list, a placement starting point, and a floor-specific weight parameter are determined (S41). In operation S41, the determining of the facility list and the placement starting point may be substantially the same as operation S21 of FIG. 4.

In operation S41, the floor-specific weight parameter may be related to an optimization weight for each of the plurality of floors of the semiconductor factory. The floor-specific weight parameter may include a first optimization weight parameter of the main floor ML, a second optimization weight parameter of the CSF floor CL, and a third optimization weight parameter of the FSF floor FL. Each of the first to third optimization weight parameters may have a value greater than or equal to 0 and less than 1, and a total sum of the first to third optimization weight parameters may be 1. The floor-specific weight parameter may be related to an optimization priority of a corresponding floor.

In some embodiments, the determining of the facility layout of each of the plurality of floors of the semiconductor factory may include determining whether a placement rule is complied with, at each time point at which a layout of a number of facilities is completed. The number of facilities may be predetermined. The determining of whether the placement rule is complied with may include determining whether the area of facilities is greater than a threshold area, determining whether an appropriate maintenance space and a facility carry-in/carry-out space are secured on each of the floors, comparing each of a degree of alignment between facilities in the horizontal direction and a degree of alignment between facilities in the vertical direction (Z direction) with a reference value, and determining whether a special rule set by an operator is complied with. The threshold area may be predetermined. If it is determined that the placement rule is not complied with, the facility layout is initialized, and the determining of the facility layout is re-started from the beginning.

In some embodiments, as a floor-specific weight parameter of a corresponding floor increases, the frequency of determining whether a placement rule for the corresponding floor is complied with may increase. When a facility layout of the corresponding floor is generated, as the frequency of determining whether the placement rule for the corresponding floor is complied with increases, the facility layout of the corresponding floor may be further optimized.

For example, while the facility layout is determined, it is determined whether placement rules for all floors are complied with at each time point at which a layout of a number of the main facilities MF corresponding to a multiple of P (i.e., P, 2P, 3P, . . . , P×N) are performed, it is determined whether the placement rules for all floors are complied with at each time point at which a layout of a number of the FSF subsidiary facilities FF corresponding to a multiple of Q (i.e., Q, 2Q, 3Q, . . . , Q×N) are performed, and it is determined whether the placement rules for all floors are complied with at each time point at which a layout of a number of the CSF subsidiary facilities CF corresponding to a multiple of R (i.e., R, 2R, 3R, . . . , R×N) are performed. For example, assuming P is 2, it is determined whether the placement rule for all floors is complied with after every 2 main facilities MF are laid out. In other words, two main facilities MF are laid out and it is determined whether the placement rule is compiled with and, assuming the placement rule is complied with, another two main facilities are laid out, and whether the placement rule is complied with is determined again, and so on. Each of P, Q, R, and N is a natural number. P, Q, and R may be determined based on a floor-specific weight parameter. As a value of an optimization weight parameter of a corresponding floor increases, it may be determined whether a placement rule is complied with whenever a layout of the relatively small number of facilities is determined.

In some embodiments, the first to third optimization weight parameters may be determined as shown in the following parameter table.

TABLE 1
Parameter Table

| | First optimi- | Second optimi- | Third optimi- |
|---|---|---|---|
| | zation weight | zation weight | zation weight |
| | parameter of | parameter of | parameter of |
| | main floor ML | CSF floor CL | FSF floor FL |
| Parameter | 0.6 | 0.1 | 0.3 |
| value | | | |

According to the parameter table, since the first optimization weight parameter of the main floor ML is greater than the second optimization weight parameter of the CSF floor CL and the third optimization weight parameter of the FSF floor FL, a value of P may be determined as a value smaller than a value of Q and smaller than a value of R. Since the third optimization weight parameter of the FSF floor FL is greater than the second optimization weight parameter of the CSF floor CL, the value of R may be determined as a value smaller than the value of Q.

In operation S42, a position of one main facility MF, a position of one FSF subsidiary facility FF, and a position of one CSF subsidiary facility CF may be determined.

In operation S43, it is determined whether a number of the main facilities MF that have been laid out is a multiple of P. When it is determined that the number of the main facilities MF that have been laid out is not a multiple of P (S43, NO), operation S42 may be performed again until the number of the main facilities MF that have been laid out is a multiple of P. That is, operation S42 may be performed at least once again. When the number of the main facilities MF that have been laid out is a multiple of P (S43, YES), it is determined whether a placement rule is complied with (S44). For example, in some embodiments, it is determined whether a facility layout of each of the floors complies with a placement rule at a corresponding time point. When it is determined that the placement rule is not complied with (S44, NO), the facility layouts of all floors, determined up to the corresponding point in time, are initialized (S50), and the determining of the facility layout is re-started from the beginning (i.e., the process returns to operation S42). When it is determined that the placement rule is complied with (S44, YES), the process proceeds to operation S45.

In operation S45, it is determined whether a number of the FSF subsidiary facilities FF that have been laid out is a multiple of Q. When it is determined that the number of the FSF subsidiary facilities FF that have been laid out is not a multiple of Q (S45, NO), operation S42 may be performed again until the number of the FSF subsidiary facilities FF that have been laid out is a multiple of Q. When the number of the FSF subsidiary facilities FF that have been laid out is a multiple of Q (S45, YES), it is determined whether a placement rule is complied with (S46). For example, it may be determined whether a facility layout of each of the floors complies with a placement rule at a corresponding time point. In operation S46, when it is determined that the placement rule is not complied with (S46, NO), the facility layouts of all floors, determined up to the corresponding point in time, are initialized (S50), and the determining of the facility layout is re-started from the beginning (i.e., the process returns to operation S42). When it is determined that the placement rule is complied with (S46, YES), the process proceeds to operation S47.

In operation S47, it is determined whether a number of the CSF subsidiary facilities CF that have been laid out is a multiple of R. When the number of the CSF subsidiary facilities CF that have been laid out is not a multiple of R (S47, NO), operation S42 may be performed again until the number of the CSF subsidiary facilities CF that have been laid out is a multiple of R. When it is determined that the number of the CSF subsidiary facilities CF that have been laid out is a multiple of R (S47, YES), it is determined whether a placement rule is complied with (S48). For example, it may be determined whether a facility layout of each of the floors complies with a placement rule at a corresponding time point. In operation S48, when it is determined that the placement rule is not complied with (S48, NO), the facility layouts of all floors, determined up to the corresponding point in time, are initialized (S50), and the determining of the facility layout is re-started from the beginning (i.e., the process returns to operation S42). When it is determined that the placement rule is complied with (S48, YES), the process proceeds to operation S49.

In operation S49, it is determined whether layouts of all facilities included in the facility list are completed. When it is determined that the layouts of all facilities included in the facility list are not completed (S49, NO), operation S42 to operation S48 may be repeatedly performed until the layouts of all facilities included in the facility list are determined. When it is determined that the layouts of all facilities included in the facility list are completed (S49, YES), the process ends.

According to some embodiments, time and cost for facility layout of a semiconductor factory may be reduced by automating facility layout generation of the semiconductor factory.

While various embodiments have been particularly shown and described with reference to the drawings, it will be understood that various changes in form and details may be made therein without departing from the spirit and scope of the following claims.

What is claimed is:

1. A method of determining a facility layout of a semiconductor factory, wherein the semiconductor factory comprises a main floor including a plurality of processing zones, a clean sub-FAB (CSF) floor under the main floor, and a facility sub-FAB (FSF) floor under the CSF floor,
the method comprising:
receiving, by at least one processor, facilities data regarding a plurality of main facilities to be placed on the main floor, a plurality of CSF subsidiary facilities to be placed on the CSF floor, and about a plurality of FSF subsidiary facilities to be placed on the FSF floor; and
determining, by the at least one processor, the facility layout including a layout of the plurality of main facilities on the main floor, a layout of the plurality of CSF subsidiary facilities on the CSF floor, and a layout of the plurality of FSF subsidiary facilities on the FSF floor,
wherein the determining comprises:
determining, for each of the plurality of processing zones, a position of each of the plurality of main facilities that are included in the processing zone;
determining, for each of the plurality of main facilities, a position of each of one or more of the plurality of FSF subsidiary facilities that are related to the main facility, based on the position of the main facility and the facilities data; and
determining, for each of the plurality of main facilities, a position of each of one or more of the plurality of CSF subsidiary facilities that are related to the main facility, based on the facilities data, the determined position of the main facility and the determined position of each of the one or more of the plurality of FSF subsidiary facilities.

2. The method of claim 1, wherein the position of each of the one or more of the plurality of CSF subsidiary facilities is determined so as not to interfere with a connection member that connects the main facility with corresponding ones of the plurality of FSF subsidiary facilities.

3. The method of claim 2, further comprising, after the determining of the position of each of the one or more of the plurality of FSF subsidiary facilities, determining a position of a hole, through which the connection member passes, in the CSF floor.

4. The method of claim 1, wherein each of the processing zones comprises a plurality of bay zones spaced apart from each other in a first direction,
determining, for each of the plurality of processing zones, the position of each of the plurality of main facilities included in the processing zone comprises determining a layout of the plurality of main facilities for each of the plurality of bay zones included in the processing zone,
wherein the plurality of main facilities are arranged in a second direction perpendicular to the first direction, in each of the plurality of bay zones.

5. The method of claim 4, further comprising:
receiving a first base drawing of the main floor, a second base drawing of the CSF floor, and a third base drawing of the FSF floor; and
determining a placement starting point of each of the processing zones among a plurality of placement starting points designated in the first base drawing,
wherein, the layouts of the plurality of main facilities for the plurality of bay zones are sequentially determined in an order from a bay zone adjacent to the determined placement starting point of the processing zone.

6. The method of claim 1, wherein determining, for each of the plurality of processing zones, a position of each of the plurality of main facilities that are included in the processing zone comprises:
determining representative main facilities among the plurality of main facilities;
determining a layout of the representative main facilities; and
determining a layout of general main facilities that do not belong to the representative main facilities among the plurality of main facilities.

7. The method of claim 6, wherein the representative main facilities comprises a first facility group comprising first-type representative facilities numbering A (wherein A is a natural number) and a second facility group comprising second-type representative facilities numbering B (wherein B is a natural number smaller than A), and
in the determining of the layout of the representative main facilities, determining of a layout of the first-type representative facilities and determining of a layout of the second-type representative facilities are sequentially performed.

8. The method of claim 1, further comprising determining a floor-specific weight parameter, wherein the floor-specific weight parameter comprises a first optimization weight parameter of the main floor, a second optimization weight parameter of the CSF floor, and a third optimization weight parameter of the FSF floor,
wherein an optimization priority for the main floor, the CSF floor, and the FSF floor is determined based on the first optimization weight parameter, the second optimization weight parameter, and the third optimization weight parameter.

9. The method of claim 8, wherein each of the first optimization weight parameter, the second optimization weight parameter, and the third optimization weight parameter has a value greater than or equal to 0 and less than 1, and
a total sum of the first optimization weight parameter, the second optimization weight parameter, and the third optimization weight parameter is 1.

10. The method of claim 8, wherein determining the facility layout further comprises:
determining whether the layout of each of the main floor, the FSF floor, and the CSF floor complies with a placement rule at each time point at which a number of main facilities that have been laid out is a multiple of P (wherein P is a natural number);
determining whether the layout of each of the main floor, the FSF floor, and the CSF floor complies with the placement rule at each time point at which a number of FSF subsidiary facilities that have been laid out is a multiple of Q (wherein Q is a natural number); and
determining whether the layout of each of the main floor, the FSF floor, and the CSF floor complies with the placement rule at each time point at which a number of CSF subsidiary facilities that have been laid out is a multiple of R (wherein R is a natural number),
wherein a value of P, a value of Q, and a value of R are determined by the first optimization weight parameter, the second optimization weight parameter, and the third optimization weight parameter, respectively.

11. The method of claim 10, wherein the first optimization weight parameter is greater than the second optimization weight parameter and greater than the third optimization weight parameter, and
the value of P is smaller than each of the value of Q and the value of R.

12. The method of claim 1, wherein, in the determining the facility layout, layouts of the plurality of main facilities of the main floor in at least two processing zones among the plurality of processing zones are simultaneously determined.

13. The method of claim 1, wherein the facilities data are provided from a library.

14. The method of claim 1, further comprising generating a layout drawing based on the facility layout.

15. A method of determining a facility layout of a semiconductor factory, wherein the semiconductor factory comprises a main floor including a plurality of processing zones, a clean sub-FAB (CSF) floor under the main floor, and a facility sub-FAB (FSF) floor under the CSF floor,
the method comprising:
receiving, by at least one processor, facilities data related to a plurality of main facilities to be placed on the main floor, about a plurality of CSF subsidiary facilities to be placed on the CSF floor, and about a plurality of FSF subsidiary facilities to be placed on the FSF floor;
determining, by the at least one processor, the facility layout including a layout of the plurality of main facilities on the main floor, a layout of the plurality of CSF subsidiary facilities on the CSF floor, and a layout of the plurality of FSF subsidiary facilities on the FSF floor; and
generating, by the at least one processor, a layout drawing based on the facility layout,
wherein determining the facility layout comprises:
determining, for each of the plurality of processing zones, a position of each of the plurality of main facilities included in the processing zone;
determining, for each of the plurality of main facilities, a position of each of one or more of the plurality of FSF subsidiary facilities that are related to the main facility, based on the position of the main facility and the facilities data;
determining a position of a hole, through which a connection member that connects the main facility with corresponding ones of the plurality of FSF subsidiary facilities passes, in the CSF floor; and
determining, for each of the plurality of main facilities, a position of each of one or more of the plurality of CSF subsidiary facilities that are related to the main facility, based on the position of the main facility and the position of each of the of the plurality of FSF subsidiary facilities that are related to the main facility,
wherein determining, for each of the plurality of processing zones, the position of each of the plurality of main facilities included in the processing zone comprises:
determining representative main facilities among the plurality of main facilities;
determining a layout of the representative main facilities; and
determining a layout of general main facilities that do not belong to the representative main facilities among the plurality of main facilities.

16. The method of claim 15, wherein the representative main facilities are classified into a plurality of facility groups, each including facilities of a same type, and
facilities belonging to a same group among the plurality of facility groups are placed consecutively.

17. The method of claim 15, wherein determining the facility layout comprises:
determining whether the layout of each of the main floor, the FSF floor, and the CSF floor complies with a placement rule at each time point at which a number of main facilities that have been laid out is a multiple of P (wherein P is a natural number);
determining whether the layout of each of the main floor, the FSF floor, and the CSF floor complies with the placement rule at each time point at which a number of FSF subsidiary facilities that have been laid out is a multiple of Q (wherein Q is a natural number); and
determining whether the layout of each of the main floor, the FSF floor, and the CSF floor complies with the placement rule at each time point at which a number of CSF subsidiary facilities that have been laid out is a multiple of R (wherein R is a natural number).

18. The method of claim 17, further comprising determining a floor-specific weight parameter, wherein the floor-specific weight parameter comprises a first optimization weight parameter of the main floor, a second optimization weight parameter of the CSF floor, and a third optimization weight parameter of the FSF floor,
a value of P, a value of Q, and a value of R are determined by the first optimization weight parameter, the second optimization weight parameter, and the third optimization weight parameter.

19. The method of claim 18, wherein each of the first optimization weight parameter, the second optimization weight parameter, and the third optimization weight parameter has a value greater than or equal to 0 and less than 1, and
a total sum of the first optimization weight parameter, the second optimization weight parameter, and the third optimization weight parameter is 1.

20. A facility layout system for a semiconductor factory, wherein the semiconductor factory comprises a main floor including a plurality of processing zones, a clean sub-FAB (CSF) floor under the main floor, and a facility sub-FAB (FSF) floor under the CSF floor, the facility layout system comprising:
an input device to which facilities data regarding a plurality of main facilities to be placed on the main floor, a plurality of CSF subsidiary facilities to be placed on the CSF floor, and a plurality of FSF subsidiary facilities to be placed on the FSF floor are input; and
a layout execution device configured to determine a facility layout of the semiconductor factory, the facility layout including a layout of the plurality of main facilities for the main floor, a layout of the plurality of CSF subsidiary facilities for the CSF floor, and a layout of the plurality of FSF subsidiary facilities for the FSF floor,
wherein the layout execution device is configured to, for each of the plurality of processing zones, sequentially perform:
determining a position of a main facility of the plurality of main facilities included in the processing zone;
determining a position of a FSF subsidiary facility of the plurality of FSF subsidiary facilities that is related to the main facility, based on the position of the main facility and the facilities data; and
determining a position of a CSF subsidiary facility of the plurality of CSF subsidiary facilities that is related to the main facility, based on the position of the main facility, the position of the FSF subsidiary facility, and the facilities data.
